(19) United States
(12) Patent Application Publication
(10) Pub. No.: US 2025/0015588 A1
(43) Pub. Date: Jan. 9, 2025

(54) POWER SUPPLY UNIT AND CONTROL METHOD OF POWER SUPPLY UNIT

(71) Applicant: Fujitsu Limited, Kawasaki-shi (JP)

(72) Inventor: Yusaku Fujiishi, Kawasaki (JP)

(73) Assignee: Fujitsu Limited, Kawasaki-shi (JP)

(21) Appl. No.: 18/739,643

(22) Filed: Jun. 11, 2024

(30) Foreign Application Priority Data
Jul. 3, 2023 (JP) 2023-109043

(51) Int. Cl. H02J 1/10

(52) U.S. Cl. CPC H02J 1/102

(57) ABSTRACT

A power supply unit includes a first power supply configured to set a first output voltage output to a first wiring to a first voltage when a first output current that flows through the first wiring is zero, and decrease the first output voltage according to an increase in the first output current, and a second power supply configured to set a second output voltage output to a second wiring to a second voltage lower than the first voltage when a second output current that flows through the second wiring coupled to the first wiring is zero, and supply the second output current when the first output voltage decreases to the second voltage.

### CROSS-REFERENCE TO RELATED APPLICATION

This application is based upon and claims the benefit of priority of the prior Japanese Patent Application No. 2023-109043, filed on Jul. 3, 2023, the entire contents of which are incorporated herein by reference.

### FIELD

The embodiment discussed herein is related to a power supply unit and a control method of the power supply unit.

### BACKGROUND

A power supply system including a plurality of power supply modules coupled in parallel has been known.

Japanese Laid-open Patent Publication No. 2011-030426 is disclosed as related art.

### SUMMARY

According to an aspect of the embodiments, a power supply unit includes a first power supply configured to set a first output voltage output to a first wiring to a first voltage when a first output current that flows through the first wiring is zero, and decrease the first output voltage according to an increase in the first output current, and a second power supply configured to set a second output voltage output to a second wiring to a second voltage lower than the first voltage when a second output current that flows through the second wiring coupled to the first wiring is zero, and supply the second output current when the first output voltage decreases to the second voltage.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration of an electronic device including a power supply unit according to an embodiment;

FIG. 2 is a characteristic diagram illustrating an exemplary efficiency curve of a power supply;

FIG. 3 is a diagram illustrating two drooping characteristics to be used when an output characteristic of each power supply is set according to a first exemplary setting;

FIG. 4 is a diagram illustrating a relationship among a device load factor, an output current, and an output voltage when the output characteristic of each power supply is set according to the first exemplary setting;

FIG. 5 is a diagram illustrating a loss reduction effect when the output characteristic of each power supply is set according to the first exemplary setting;

FIG. 6 is a diagram illustrating two drooping characteristics to be used when the output characteristic of each power supply is set according to a second exemplary setting;

FIG. 7 is a diagram illustrating a relationship among a device load factor, an output current, and an output voltage when the output characteristic of each power supply is set according to the second exemplary setting;

FIG. 8 is a diagram illustrating a loss reduction effect when the output characteristic of each power supply is set according to the second exemplary setting;

FIG. 9 is a diagram illustrating two drooping characteristics to be used when the output characteristic of each power supply is set according to a third exemplary setting;

FIG. 10 is a diagram illustrating a relationship among a device load factor, an output current, and an output voltage when the output characteristic of each power supply is set according to the third exemplary setting;

FIG. 11 is a diagram illustrating a loss reduction effect when the output characteristic of each power supply is set according to the third exemplary setting;

FIG. 12 is a block diagram illustrating an exemplary configuration of the power supply;

FIG. 13 is a diagram exemplifying a droop inclination and an offset regulation circuit;

FIG. 14 is a flowchart illustrating exemplary operation of a device control unit;

FIG. 15 is a flowchart illustrating exemplary operation of the power supply; and

FIG. 16 is a hardware configuration diagram of a control device.

### DESCRIPTION OF EMBODIMENTS

When voltages output from the plurality of power supplies coupled in parallel to a common load are set to mutually the same voltage value, a proportion of the load current to be borne is the same among the plurality of power supplies. Thus, efficiency of each of the plurality of power supplies may decrease in a state where the total load applied to the plurality of power supplies is low or the like.

Hereinafter, an embodiment of techniques capable of suppressing a decrease in efficiency will be described.

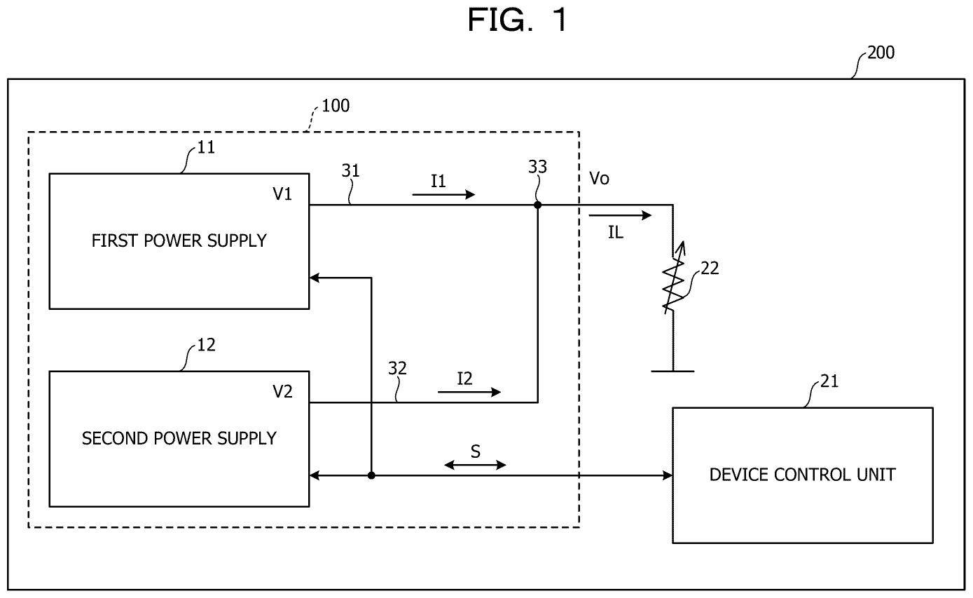

FIG. 1 is a diagram illustrating an exemplary configuration of an electronic device including a power supply unit according to an embodiment. An electronic device 200 illustrated in FIG. 1 includes a power supply unit 100 that generates a direct current (DC) output voltage Vo, a load 22 that operates with DC power supplied from the power supply unit 100, and a device control unit 21 coupled to the power supply unit 100 in such a manner that signals may be transmitted therebetween.

While specific examples of the electronic device 200 include a server, a supercomputer, a personal computer, a mobile computer, a smartphone, a tablet, a mobile phone, and the like, the electronic device 200 is not limited thereto.

The power supply unit 100 is a power supply device that generates the DC output voltage Vo output toward the load 22. The power supply unit 100 includes a first power supply 11 and a second power supply 12.

The first power supply 11 generates and outputs a first output voltage V1 to first wiring 31. The second power supply 12 generates and outputs a second output voltage V2 to second wiring 32. The second wiring 32 is coupled to the first wiring 31 at a connection point 33. A first output current I1 flowing from the first power supply 11 to the first wiring 31 and a second output current I2 flowing from the second power supply 12 to the second wiring 32 join together at the connection point 33. The power supply unit 100 supplies an output current IL, which is the sum of the first output current I1 and the second output current I2, to the load 22 coupled to the connection point 33. The output current IL is also referred to as a load current IL.

The first power supply 11 is a power supply circuit that generates and outputs DC power of the first output voltage V1 from alternate current (AC) or DC input power supplied from an external power supply (not illustrated). The second power supply 12 is a power supply circuit that generates and outputs DC power of the second output voltage V2 from AC or DC input power supplied from an external power supply (not illustrated). The external power supply (not illustrated) may be a power supply commonly provided to the first power supply 11 and the second power supply 12, or may be a power supply separately provided to the first power supply 11 and the second power supply 12.

The load 22 operates using a DC output voltage Vout generated by the power supply unit 100 as a power supply voltage. The load 22 may be a single load, or may be a combination of a plurality of loads. While specific examples of the load 22 include a processor such as a central processing unit (CPU), a hard disk, a memory, a fan, and the like, the load 22 is not limited thereto.

The device control unit 21 transmits, to the first power supply 11 or to the second power supply 12, a signal S for setting whether to operate each of the first power supply 11 and the second power supply 12 as a main power supply or as a standby power supply. By transmitting the signal S, the device control unit 21 sets whether to operate each of the first power supply 11 and the second power supply 12 as a main power supply or as a standby power supply.

For example, the device control unit 21 may be communicably coupled to the first power supply 11 and the second power supply 12, and may exchange the signal S with the first power supply 11 or the second power supply 12 according to a communication protocol such as a power management bus (PMBus) or the like. In the case of the PMBus, the signal S includes a data signal SDA and a clock signal SCL.

Note that the signal S for setting whether to operate each of the first power supply 11 and the second power supply 12 as a main power supply or as a standby power supply is not limited to being exchanged according to a communication protocol such as the PMBus or the like. For example, the signal S may be a setting signal generated by hardware such as a pull-down resistor, a pull-up resistor, or the like.

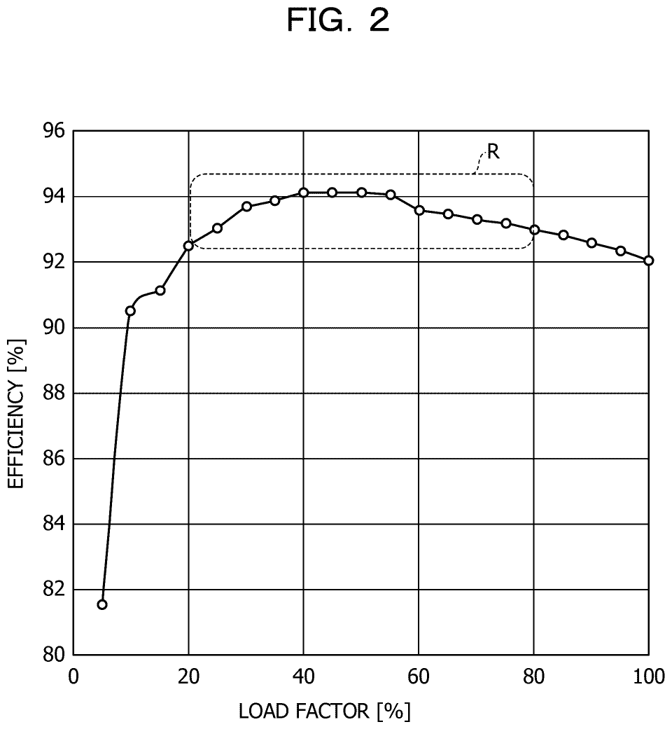

FIG. 2 is a characteristic diagram illustrating an exemplary efficiency curve of a power supply. Both the first power supply 11 and the second power supply 12 have a characteristic that efficiency rapidly decreases in a region where a load factor is low as illustrated in FIG. 2. The load factor represents a ratio of actual output power to rated output. The efficiency represents a ratio of output power to input power. By operating each of the first power supply 11 and the second power supply 12 at a highly efficient load factor R (e.g., 20% or higher and 80% or lower in the case of FIG. 2), the efficiency of the entire power supply unit 100 improves, and power saving of the power supply unit 100 and the electronic device 200 may be achieved.

However, when the first output voltage V1 of the first power supply 11 and the second output voltage V2 of the second power supply 12 are set to the same voltage value, the first power supply 11 and the second power supply 12 share the load current IL caused by the load 22 half-and-half. Thus, in a state where the total load applied to the first power supply 11 and the second power supply 12 by the load 22 is low (in a state where the load current IL is low), each of the first power supply 11 and the second power supply 12 may operate at a less efficient load factor (e.g., region on the left side of the region of the load factor R in FIG. 2). In this case, the efficiency of each of the first power supply 11 and the second power supply 12 decreases, and the efficiency of the entire power supply unit 100 decreases.

For example, the power supply unit 100 is designed to be capable of dealing with the maximum load that may be generated by the load 22. Thus, when a time during which the load 22 operates at the maximum load or at a large load close to the maximum load is very short with respect to the entire operation time, each of the first power supply 11 and the second power supply 12 operates for a relatively long time at a less efficient load factor.

Each of output characteristics of the first power supply 11 and the second power supply 12 according to the present embodiment is set to a drooping characteristic adjusted such that each of the first power supply 11 and the second power supply 12 operates at the highly efficient load factor R (e.g., 20% or higher and 80% or lower in the case of FIG. 2). As a result, the efficiency of the entire power supply unit 100 improves, and power saving of the power supply unit 100 and the electronic device 200 may be achieved.

Next, a plurality of exemplary settings when the drooping characteristic is set to each of the output characteristics of the first power supply 11 and the second power supply 12 will be described. The drooping characteristic has an output characteristic in which a drop amount of an output voltage from a power supply increases as an output current from the power supply increases.

In FIG. 1, the output characteristic of the first power supply 11 is set to the drooping characteristic that detects the first output current I1 flowing through the first wiring 31 and decreases the first output voltage V1 to the first wiring 31 as the detected first output current I1 increases. Likewise, the output characteristic of the second power supply 12 is set to the drooping characteristic that detects the second output current I2 flowing through the second wiring 32 and decreases the second output voltage V2 to the second wiring 32 as the detected second output current I2 increases.

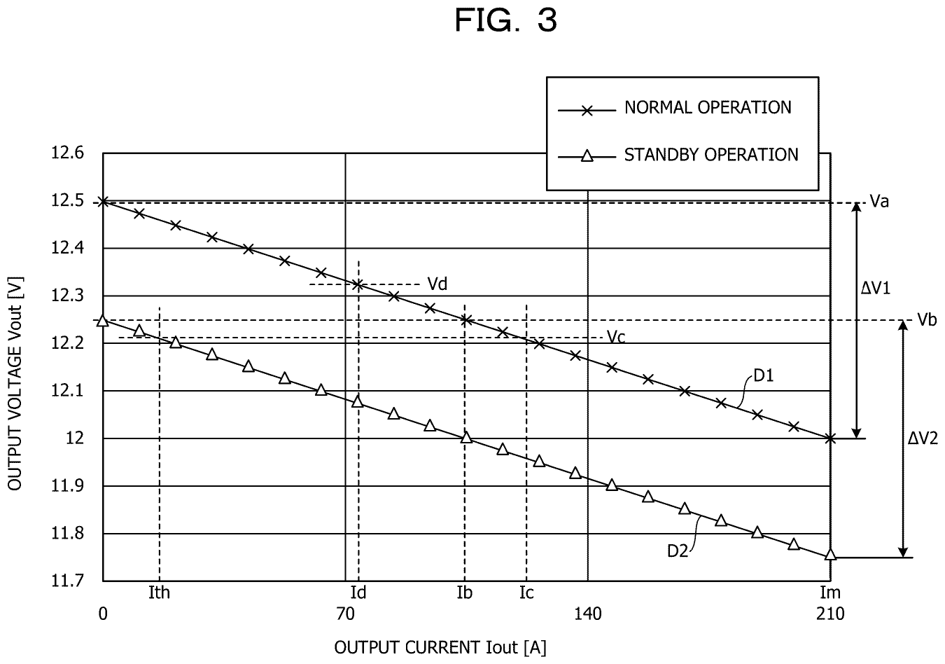

FIG. 3 is a diagram illustrating two drooping characteristics to be used when the output characteristic of each power supply is set according to a first exemplary setting. An output current Iout of the horizontal axis represents the first output current I1 from the first power supply 11 to the first wiring 31 or the second output current I2 from the second power supply 12 to the second wiring 32. An output voltage Vout of the vertical axis represents the first output voltage V1 from the first power supply 11 to the first wiring 31 or the second output voltage V2 from the second power supply 12 to the second wiring 32.

When the first power supply 11 is set to operate as a main power supply based on the signal S, it sets the output characteristic of the first output voltage V1 with respect to the first output current I1 to a first drooping characteristic D1 at a time of normal operation. The first drooping characteristic D1 is expressed as follows.

$$Vout = Va - Iout \times ( Δ V 1 / I m )$$

Va represents the first output voltage V1 when the first output current I1 is zero (e.g., 12.5 [V]). Im represents the first output current I1 at the time of the maximum load or the maximum rating (e.g., 210 [A]). ΔV1 represents a voltage drop amount of the first output voltage V1 when the first output current I1 is the maximum current Im (e.g., 0.5 [V]). (ΔV1/Im) represents a droop inclination of the first drooping characteristic D1.

When the first output current I1 flowing through the first wiring 31 is zero, the first power supply 11 sets the first output voltage V1 to the first wiring 31 to the first voltage Va according to the first drooping characteristic D1. Then, according to the first drooping characteristic D1, the first power supply 11 decreases the first output voltage V1 from the first voltage Va as the first output current I1 increases from zero.

Meanwhile, when the second power supply 12 is set to operate as a standby power supply based on the signal S, it sets the output characteristic of the second output voltage V2 with respect to the second output current I2 to a second drooping characteristic D2 at a time of standby operation. The second drooping characteristic D2 is expressed as follows.

$$Vout = Vb - Iout \times ( Δ V 2 / I m )$$

Vb represents the second output voltage V2 when the second output current I2 is zero (e.g., 12.25 [V]). Im represents the second output current I2 at the time of the maximum load or the maximum rating (e.g., 210 [A]). ΔV2 represents a voltage drop amount of the second output voltage V2 when the second output current I2 is the maximum current Im (e.g., 0.5 [V]). (ΔV2/Im) represents a droop inclination of the second drooping characteristic D2.

The second drooping characteristic D2 has the droop inclination same as that of the first drooping characteristic D1, and is offset from the first drooping characteristic D1 by a voltage offset (Va-Vb).

When the second output current I2 flowing through the second wiring 32 is zero, the second power supply 12 sets the second output voltage V2 to the second wiring 32 to the second voltage Vb according to the second drooping characteristic D2. The second voltage Vb has a value lower than the first voltage Va. Then, according to the second drooping characteristic D2, the second power supply 12 decreases the second output voltage V2 from the second voltage Vb as the second output current I2 increases from zero.

In the configuration in which the output unit of the first power supply 11 and the output unit of the second power supply 12 are commonly coupled the connection point 33 as illustrated in FIG. 1, in a case where the first output voltage V1 and the second output voltage V2 are different from each other, the power supply having the higher output voltage bears most of the load current when the load current (output current IL) increases. However, according to the output characteristics exemplified in FIG. 3, the first output voltage V1 when the first output current I1 is zero is set to the first voltage Va, and the second output voltage V2 when the second output current I2 is zero is set to the second voltage Vb.

Since the second voltage Vb is lower than the first voltage Va, the first power supply 11 having the higher output voltage bears most of the load current IL when the load current IL increases from zero. For example, while the first power supply 11 starts to output the first output current I1 as the load current IL increases from zero, the second power supply 12 does not output the second output current I2. In a low current region where the load current IL is equal to or higher than zero and lower than a current value Ib, the first output voltage V1 is higher than the second voltage Vb. Thus, in the low current region where the load current IL is equal to or higher than zero and lower than the current value Ib, the first power supply 11 outputs the first output current I1 according to the first drooping characteristic D1, and the second power supply 12 does not output the second output current I2 (output current IL=first output current I1).

As illustrated in FIG. 3, the second power supply 12 has the second drooping characteristic D2 having the droop inclination same as that of the first drooping characteristic D1. As a result, when the first output voltage V1 decreases to the second voltage Vb, the second power supply 12 decreases the second output voltage V2 according to the increase in the second output current I2 with the inclination same as the inclination at which the first output voltage V1 decreases with respect to the increase in the first output current I1.

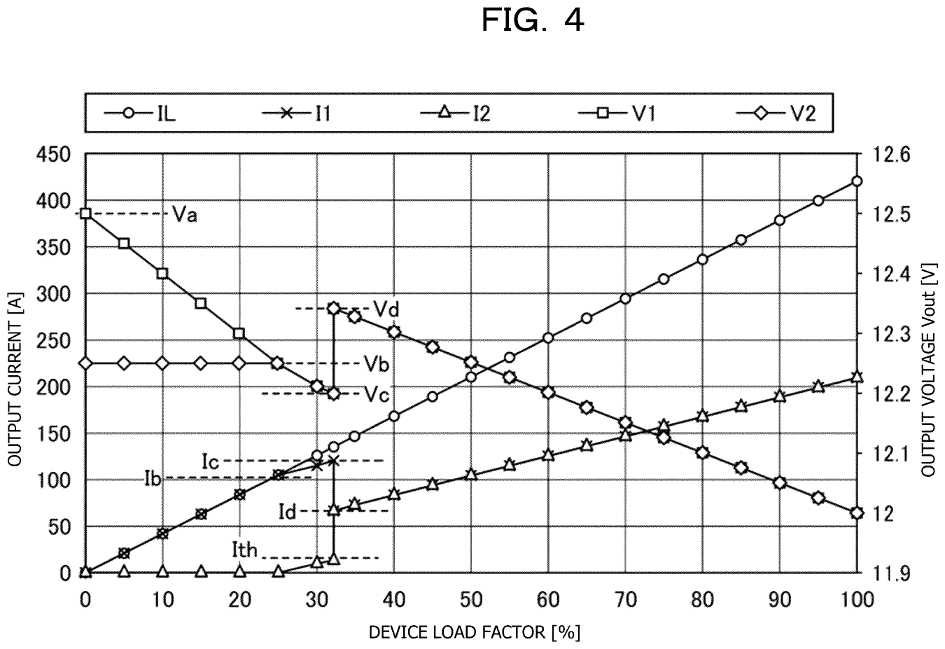

FIG. 4 is a diagram illustrating a relationship among the device load factor, the output current, and the output voltage when the output characteristic of each power supply is set according to the first exemplary setting using the two drooping characteristics of FIG. 3. The device load factor of the horizontal axis represents a ratio of the total output power obtained by adding the actual output power of the first power supply 11 and the actual output power of the second power supply 12 to the total rated output obtained by adding the rated output of the first power supply 11 and the rated output of the second power supply 12.

When the load current IL is zero, the second output voltage V2 is set to the second voltage Vb lower than the first voltage Va set as the first output voltage V1. Thus, while the first output current I1 increases as the load current IL increases from zero, the second output current I2 remains at zero and does not increase. As the first output current I1 increases due to the increase in the load current IL, the first output voltage V1 gradually decreases from the first voltage Va according to the first drooping characteristic D1. When the first output voltage V1 decreases to the second voltage Vb, the first output voltage V1 becomes equal to the second output voltage V2 set to the second voltage Vb.

When the first output current I1 starts to exceed the current value Ib, due to the further increase in the load current IL, the second power supply 12 starts to supply the second output current I2. As the output current IL increases from the current value Ib, the first power supply 11 further increases the first output current I1 from the current value Ib, and the second power supply 12 increases the second output current I2 from zero.

For example, according to the first drooping characteristic D1, the first power supply 11 decreases the first output voltage V1 from the second voltage Vb as the first output current I1 increases from the current value Ib. Meanwhile, according to the second drooping characteristic D2, the second power supply 12 decreases the second output voltage V2 from the second voltage Vb as the second output current I2 increases from zero. At this time, the second power supply 12 decreases the second output voltage V2 according to the increase in the second output current I2 so that the second output voltage V2 becomes equal to the first output voltage V1.

However, in the low current region after the second output current I2 starts flowing, the second power supply 12 operates at a less efficient load factor (see FIG. 2). Thus, when the detected second output current I2 rises above a predetermined threshold current Ith, the second power supply 12 switches the output characteristic of the first output voltage V1 with respect to the first output current I1 from the second drooping characteristic D2 at the time of standby operation to the first drooping characteristic D1 at the time of normal operation (see FIG. 3). As a result, the second power supply 12 operates according to the first drooping characteristic D1 in the same manner as the first power supply 11, whereby the output current IL is shared between the first power supply 11 and the second power supply 12 half-and-half. Accordingly, as illustrated in FIG. 4, the first output current I1 decreases from a current value Ic to a current value Id, the second output current I2 increases from the threshold current Ith to the current value Id, and the first output voltage V1 and the second output voltage V2 increase from a third voltage Vc to a fourth voltage Vd. Therefore, when the second output current I2 rises above the predetermined threshold current Ith, the second output current I2 and the second output voltage V2 rapidly increase, whereby the second power supply 12 operates at a highly efficient load factor.

In a high current region where the second output current I2 is equal to or higher than the threshold current Ith, the first power supply 11 decreases the first output voltage V1 from the fourth voltage Vd as the first output current I1 increases from the current value Id according to the first drooping characteristic D1. Meanwhile, according to the first drooping characteristic D1, the second power supply 12 also decreases the second output voltage V2 from the fourth voltage Vd as the second output current I2 increases from the current value Id.

Therefore, when the second output current I2 is higher than the threshold current Ith, the second power supply 12 decreases the second output voltage V2 according to the increase in the second output current I2 such that the second output voltage V2 becomes equal to the first output voltage V1 and the second output current I2 becomes equal to the first output current I1. Meanwhile, when the second output current I2 is higher than zero and lower than the threshold current Ith, the second power supply 12 decreases the second output voltage V2 according to the increase in the second output current I2 such that the second output voltage V2 becomes equal to the first output voltage V1.

As described above, when the first output current I1 flowing through the first wiring 31 is zero, the first power supply 11 sets the first output voltage V1 to the first wiring 31 to the first voltage Va, and decreases the first output voltage V1 according to the increase in the first output current I1. When the second output current I2 flowing through the second wiring 32 coupled to the first wiring 31 is zero, the second power supply 12 sets the second output voltage V2 to the second wiring 32 to the second voltage Vb lower than the first voltage Va, and supplies the second output current I2 when the first output voltage V1 decreases to the second voltage Vb. Since the power supply unit 100 according to the present embodiment has such a configuration, the second output voltage V2 is maintained lower than the first output voltage V1 in a low load state where the load current IL is low. Thus, while the first power supply 11 may be used at a highly efficient load factor as the first power supply 11 bears most of the load current IL, usage of the second power supply 12 at a less efficient load factor may be suppressed as the output of the second power supply 12 stops. Therefore, it becomes possible to suppress a decrease in efficiency of the entire power supply unit 100 in a low load state.

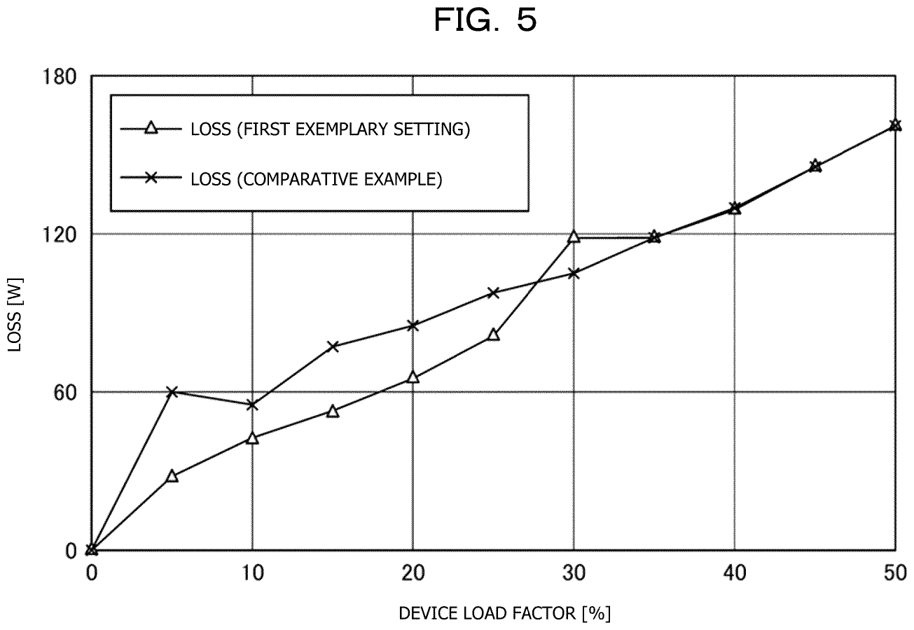

FIG. 5 is a diagram illustrating a loss reduction effect when the output characteristic of each power supply is set according to the first exemplary setting using the two drooping characteristics of FIG. 3. The device load factor of the horizontal axis represents a ratio of the total output power obtained by adding the actual output power of the first power supply 11 and the actual output power of the second power supply 12 to the total rated output obtained by adding the rated output of the first power supply 11 and the rated output of the second power supply 12. A loss of the vertical axis represents a loss of the power supply unit 100 (=input power of the power supply unit 100−output power of the power supply unit 100).

The “comparative example” represents a case where the output characteristics of both the first power supply 11 and the second power supply 12 are fixed to the first drooping characteristic D1. The “first exemplary setting” represents a case where the output characteristic of the first power supply 11 is fixed to the first drooping characteristic D1 and the output characteristic of the second power supply 12 is switched and set from the second drooping characteristic D2 to the first drooping characteristic D1 as illustrated in FIG. 4.

In the case of the “comparative example”, the first power supply 11 and the second power supply 12 equally share the load current IL. Thus, in the low load state, the first power supply 11 and the second power supply 12 operate at a less efficient load factor. Therefore, the loss of the entire power supply unit 100 increases, and the overall efficiency decreases. On the other hand, in the case of the “first exemplary setting”, the first power supply 11 bears most of the load current IL in the low load state. Thus, while the first power supply 11 operates at a highly efficient load factor, the second power supply 12 does not operate at a less efficient load factor. Therefore, an increase in the loss of the entire power supply unit 100 is suppressed, and a decrease in the overall efficiency is suppressed.

In the case of the “first exemplary setting”, the loss at the device load factor around 30% temporarily increases. However, when the second output current I2 rises above the threshold current Ith, the output characteristic of the second power supply 12 switches from the second drooping characteristic D2 to the first drooping characteristic D1, whereby it becomes possible to suppress continuous operation of the second power supply 12 at the less efficient load factor. Therefore, it becomes possible to suppress a decrease in efficiency of the entire power supply unit 100.

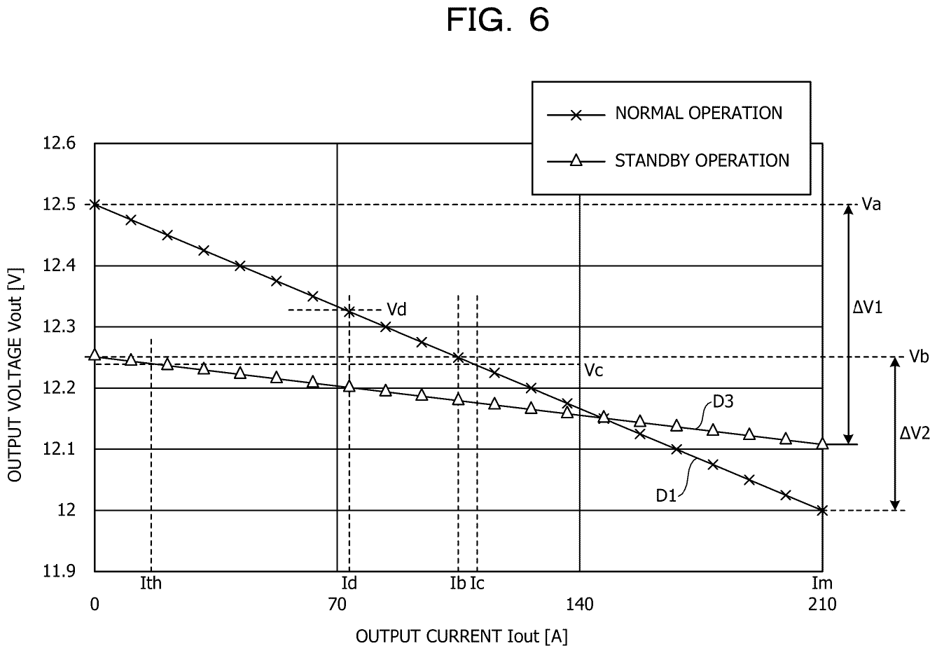

FIG. 6 is a diagram illustrating two drooping characteristics to be used when the output characteristic of each power supply is set according to a second exemplary setting. In the second exemplary setting, descriptions similar to those of the first exemplary setting will be omitted by incorporating the descriptions above.

When the first power supply 11 is set to operate as a main power supply based on the signal S, it sets the output characteristic of the first output voltage V1 with respect to the first output current I1 to a first drooping characteristic D1 at a time of normal operation. Meanwhile, when the second power supply 12 is set to operate as a standby power supply based on the signal S, it sets the output characteristic of the second output voltage V2 with respect to the second output current I2 to a third drooping characteristic D3 at the time of standby operation. The third drooping characteristic D3 is expressed as follows.

$$Vout = Vb - Iout \times ( Δ V 2 / I m )$$

The second output voltage V2 when the second output current I2 is zero is offset from the first output voltage V1 when the first output current I1 is zero by a voltage offset (Va-Vb).

As illustrated in FIG. 6, the second power supply 12 has the third drooping characteristic D3 having the droop inclination smaller than that of the first drooping characteristic D1. As a result, when the first output voltage V1 decreases to the second voltage Vb, the second power supply 12 decreases the second output voltage V2 according to the increase in the second output current I2 with the inclination smaller than the inclination at which the first output voltage V1 decreases with respect to the increase in the first output current I1.

When the detected second output current I2 rises above the predetermined threshold current Ith, the second power supply 12 switches the output characteristic of the first output voltage V1 with respect to the first output current I1 from the third drooping characteristic D3 at the time of standby operation to the first drooping characteristic D1 at the time of normal operation. For example, when the second output current I2 is lower than the threshold current Ith, the second power supply 12 decreases the second output voltage V2 according to the increase in the second output current I2 with the inclination (third drooping characteristic D3) smaller than the inclination at which the first output voltage V1 decreases with respect to the increase in the first output current I1. On the other hand, when the second output current I2 is higher than the threshold current Ith, the second power supply 12 decreases the second output voltage V2 according to the increase in the second output current I2 with the inclination (first drooping characteristic D1) same as the inclination at which the first output voltage V1 decreases with respect to the increase in the first output current I1.

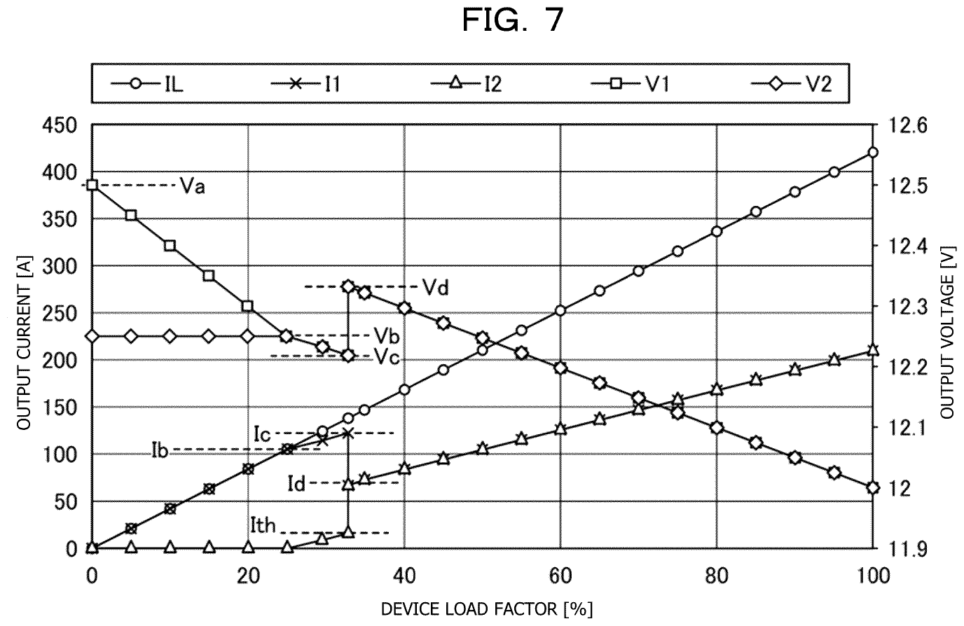

FIG. 7 is a diagram illustrating a relationship among the device load factor, the output current, and the output voltage when the output characteristic of each power supply is set according to the second exemplary setting using the two drooping characteristics of FIG. 6. In a similar manner to the first exemplary setting, when the second output current I2 is higher than the threshold current Ith, the second power supply 12 decreases the second output voltage V2 according to the increase in the second output current I2 such that the second output voltage V2 becomes equal to the first output voltage V1 and the second output current I2 becomes equal to the first output current I1. Meanwhile, when the second output current I2 is higher than zero and lower than the threshold current Ith, the second power supply 12 decreases the second output voltage V2 according to the increase in the second output current I2 such that the second output voltage V2 becomes equal to the first output voltage V1. Also in the second exemplary setting, a decrease in efficiency of the entire power supply unit 100 may be suppressed in the low load state in a similar manner to the first exemplary setting.

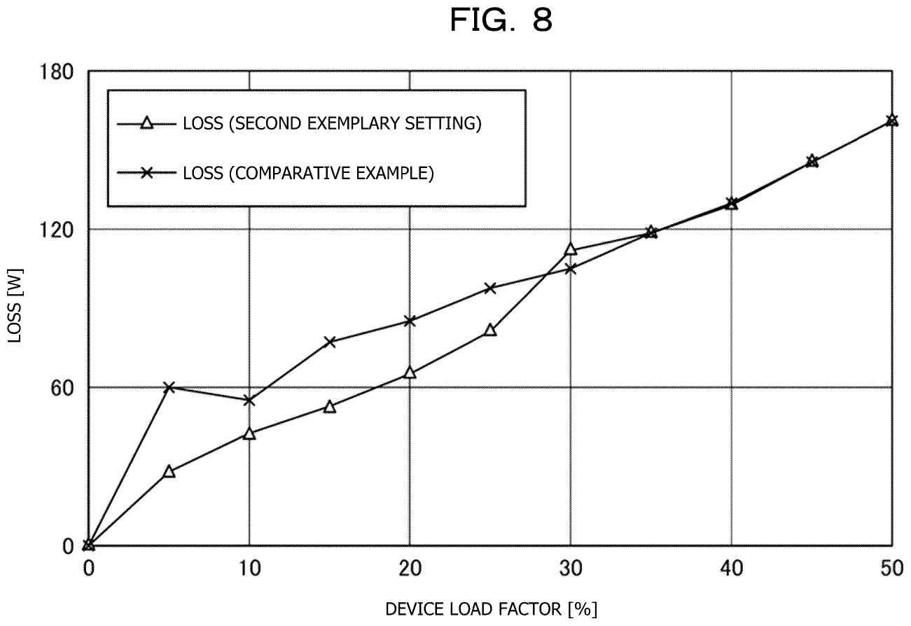

FIG. 8 is a diagram illustrating a loss reduction effect when the output characteristic of each power supply is set according to the second exemplary setting using the two drooping characteristics of FIG. 6. The “comparative example” represents a case where the output characteristics of both the first power supply 11 and the second power supply 12 are fixed to the first drooping characteristic D1. The “second exemplary setting” represents a case where the output characteristic of the first power supply 11 is fixed to the first drooping characteristic D1 and the output characteristic of the second power supply 12 is switched and set from the third drooping characteristic D3 to the first drooping characteristic D1 as illustrated in FIG. 7. Also in the second exemplary setting, an increase in the loss of the entire power supply unit 100 is suppressed, and a decrease in the overall efficiency is suppressed in a similar manner to the first exemplary setting.

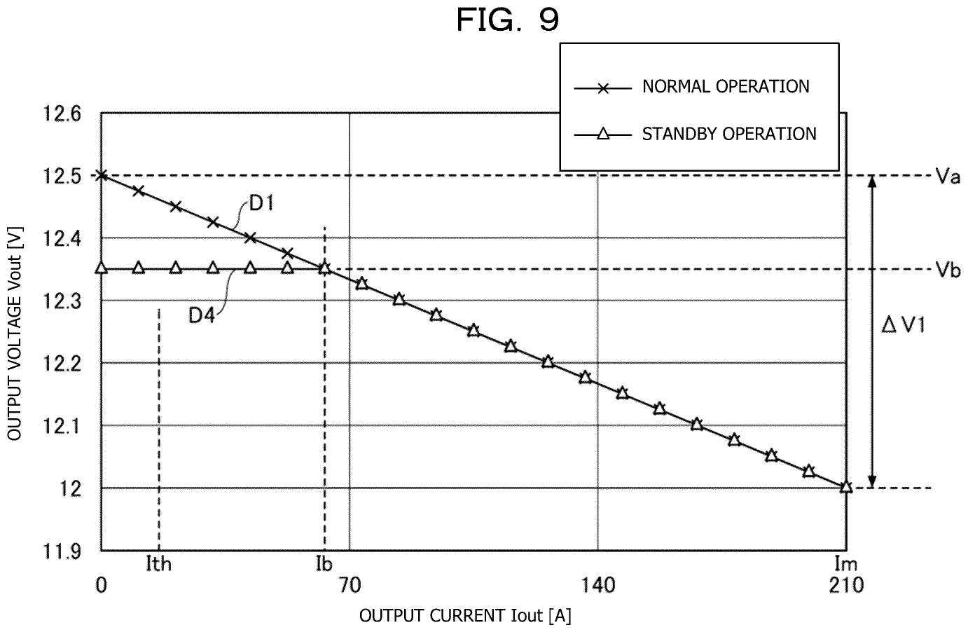

FIG. 9 is a diagram illustrating two drooping characteristics to be used when the output characteristic of each power supply is set according to a third exemplary setting. In the third exemplary setting, descriptions similar to those of the first exemplary setting will be omitted by incorporating the descriptions above.

When the first power supply 11 is set to operate as a main power supply based on the signal S, it sets the output characteristic of the first output voltage V1 with respect to the first output current I1 to a first drooping characteristic D1 at a time of normal operation. Meanwhile, when the second power supply 12 is set to operate as a standby power supply based on the signal S, it sets the output characteristic of the second output voltage V2 with respect to the second output current I2 to a fourth drooping characteristic D4 at the time of standby operation. The fourth drooping characteristic D4 is expressed as follows.

$$Vout = Vb ( 0 \leq Iout < Ib )$$

$$Vout = Va - Iout \times ( Δ V 1 / I m ) ( Ib \leq Iout \leq I m )$$

The fourth drooping characteristic D4 has a droop inclination smaller than that of the first drooping characteristic D1 in the region where the output current is equal to or higher than zero and lower than the current value Ib, and has a droop inclination same as that of the first drooping characteristic D1 (e.g., characteristic overlapping with the first drooping characteristic D1) in the high current region of equal to or higher than the current value Ib.

The second power supply 12 has the fourth drooping characteristic D4 having the droop inclination same as that of the first drooping characteristic D1 in the high current region of equal to or higher than the current value Ib. As a result, when the first output voltage V1 decreases to the second voltage Vb, the second power supply 12 decreases the second output voltage V2 according to the increase in the second output current I2 with the inclination same as the inclination at which the first output voltage V1 decreases with respect to the increase in the first output current I1.

When the detected second output current I2 rises above the predetermined threshold current Ith, the second power supply 12 switches the output characteristic of the first output voltage V1 with respect to the first output current I1 from the fourth drooping characteristic D4 at the time of standby operation to the first drooping characteristic D1 at the time of normal operation. For example, when the second output current I2 is lower than the threshold current Ith, the second power supply 12 sets the output characteristic of the second output voltage V2 with respect to the second output current I2 to an inclination smaller than the inclination at which the first output voltage V1 decreases with respect to the increase in the first output current I1. The smaller inclination in this example indicates the fourth drooping characteristic D4 of the portion where the inclination is zero. On the other hand, when the second output current I2 is higher than the threshold current Ith, the second power supply 12 decreases the second output voltage V2 according to the increase in the second output current I2 with the inclination (first drooping characteristic D1) same as the inclination at which the first output voltage V1 decreases with respect to the increase in the first output current I1.

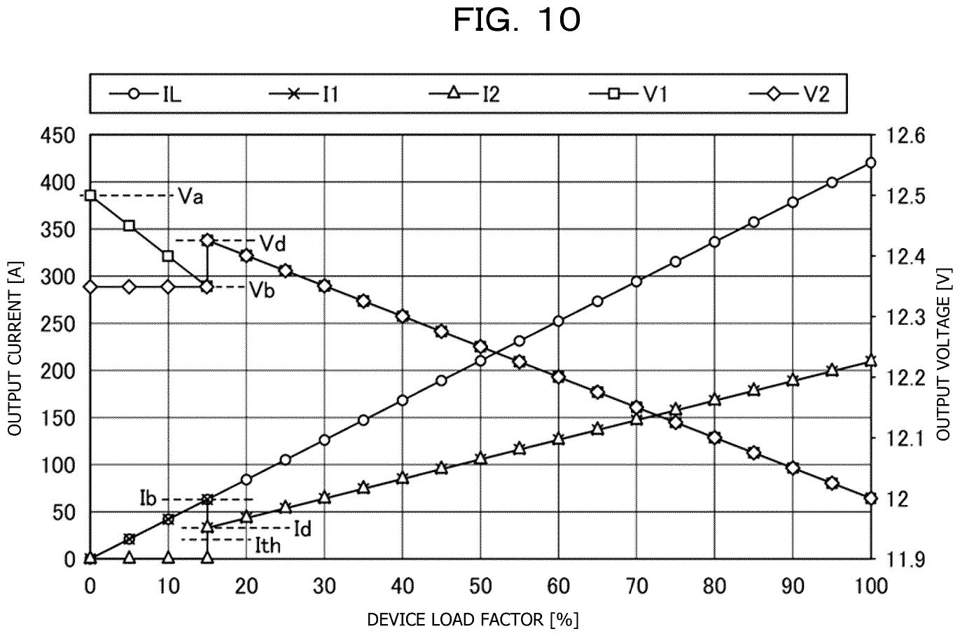

FIG. 10 is a diagram illustrating a relationship among the device load factor, the output current, and the output voltage when the output characteristic of each power supply is set according to the third exemplary setting using the two drooping characteristics of FIG. 9. In a similar manner to the first exemplary setting, when the second output current I2 is higher than the threshold current Ith, the second power supply 12 decreases the second output voltage V2 according to the increase in the second output current I2 such that the second output voltage V2 becomes equal to the first output voltage V1 and the second output current I2 becomes equal to the first output current I1. When the second output current I2 is higher than zero and lower than the threshold current Ith, the second power supply 12 fixes the second output voltage V2 to the second voltage Vb in the state where the second output current I2 is maintained at zero. Also in the second exemplary setting, a decrease in efficiency of the entire power supply unit 100 may be suppressed in the low load state in a similar manner to the first exemplary setting.

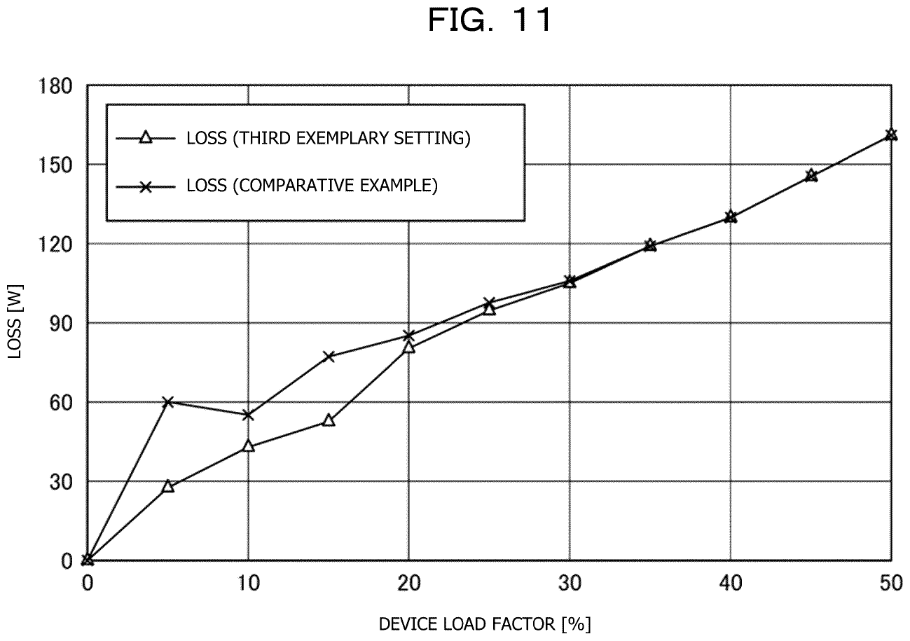

FIG. 11 is a diagram illustrating a loss reduction effect when the output characteristic of each power supply is set according to the third exemplary setting using the two drooping characteristics of FIG. 9. The “comparative example” represents a case where the output characteristics of both the first power supply 11 and the second power supply 12 are fixed to the first drooping characteristic D1. The “third exemplary setting” represents a case where the output characteristic of the first power supply 11 is fixed to the first drooping characteristic D1 and the output characteristic of the second power supply 12 is switched and set from the fourth drooping characteristic D4 to the first drooping characteristic D1 as illustrated in FIG. 10. Also in the third exemplary setting, an increase in the loss of the entire power supply unit 100 is suppressed, and a decrease in the overall efficiency is suppressed in a similar manner to the first exemplary setting.

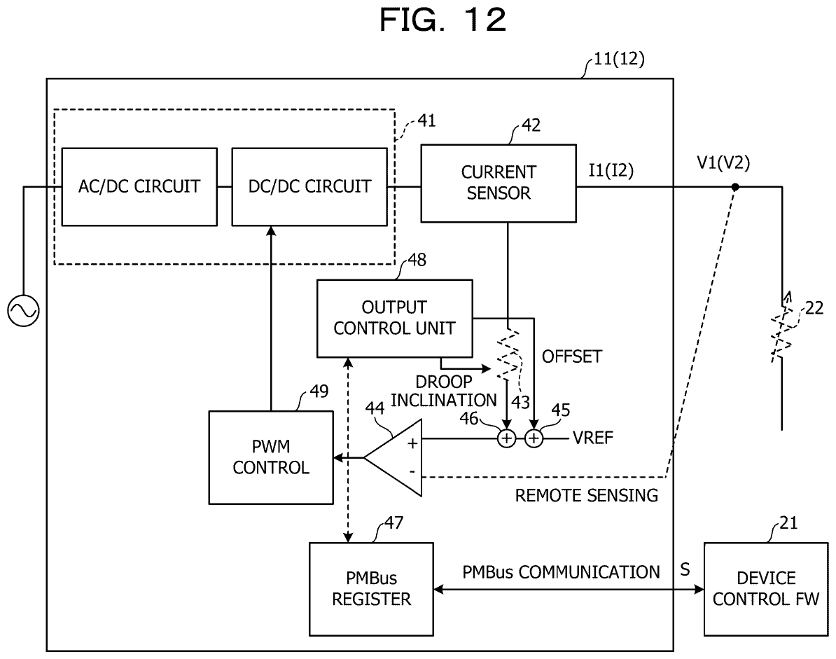

FIG. 12 is a block diagram illustrating an exemplary configuration of the power supply. Each of the first power supply 11 and the second power supply 12 may have a configuration as illustrated in FIG. 12. Each of the first power supply 11 and the second power supply 12 includes a power conversion circuit 41, a current sensor 42, a variable resistor 43, an amplifier 44, regulators 45 and 46, a pulse width modulation (PWM) control unit 49, a register 47, and an output control unit 48.

The power conversion circuit 41 converts the input power supplied from the external power supply into output power according to PWM signals generated by the PWM control unit 49. The power conversion circuit 41 includes an AC/DC conversion circuit that converts an alternating current (AC) supplied from the external power supply into a direct current (DC) and outputs it, and a DC/DC conversion circuit that converts the direct current (DC) output from the AC/DC conversion circuit into a direct current (DC) and outputs it.

In the first power supply 11, the current sensor 42 detects the first output current I1, and outputs current sense signals proportional to the magnitude of the first output current I1. The current sense signal is input to a first input unit of the regulator 46, such as an adder, via the variable resistor 43. A certain reference voltage VREF is input to a second input unit of the regulator 46 via the regulator 45, such as an adder. The sum of the current sense signal and the reference voltage VREF is input to a non-inverting input unit of the amplifier 44. Voltage detection signals proportional to the magnitude of the first output voltage V1 detected by remote sensing is input to an inverting input unit of the amplifier 44. The PWM control unit 49 controls a duty ratio of the PWM signals for controlling switching of the power conversion circuit 41 according to output signals of the amplifier 44. As a result, it becomes possible to achieve the drooping characteristic that decreases the first output voltage V1 according to an increase in the first output current I1. Since the second power supply 12 also has a similar configuration, it becomes possible to achieve the drooping characteristic that decreases the second output voltage V2 according to an increase in the second output current I2.

The first power supply 11 and the second power supply 12 are coupled in parallel as a power supply unit (PSU) in which the droop inclination and the output voltage may be adjusted by the PMBus. The device control unit 21 sets the droop inclination and the output voltage by the PMBus before power-on of each PSU. The PSU set as the standby power supply switches the drooping characteristic based on a detection value of the output current supplied by itself.

For example, the device control unit 21 transmits the signal S for setting whether to operate as a standby power supply by the PMBus. Each of the first power supply 11 and the second power supply 12 includes the register 47 for setting a main power supply or a standby power supply. In a case of operating the second power supply 12 as a standby power supply, the device control unit 21 sets a flag for operating as a standby power supply in the register 47 in the second power supply 12. In a case of operating the first power supply 11 as a main power supply, the device control unit 21 sets a flag for operating as a main power supply in the register 47 in the first power supply 11, or does not set the flag for operating as a standby power supply in the register 47 in the first power supply 11.

The output control unit 48 sets whether to operate the power supply controlled by itself as a main power supply or as a standby power supply according to the flag set in the register 47. The output control unit 48 adjusts a resistance value of the variable resistor 43 and a voltage value to be added to the reference voltage VREF by the regulator 45 according to the setting of the flag as to whether to operate as a main power supply or as a standby power supply. The output control unit 48 is enabled to adjust the droop inclination by adjusting the resistance value of the variable resistor 43, and is enabled to adjust the voltage offset of the drooping characteristic by adjusting the voltage value to be added to the reference voltage VREF. As a result, when the output control unit 48 causes the power supply controlled by itself to operate as a main power supply, it is enabled to adjust the output characteristic to a desired drooping characteristic such as the drooping characteristic D1 described above. On the other hand, when the output control unit 48 causes the power supply controlled by itself to operate as a standby power supply, it is enabled to adjust the output characteristic to a desired drooping characteristic such as drooping characteristics D2, D3, or D4 described above.

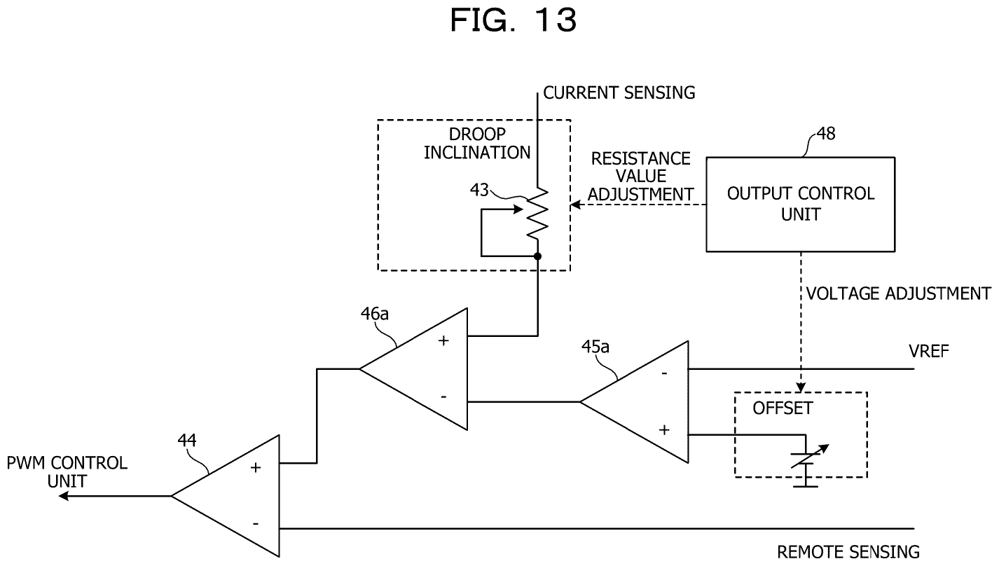

FIG. 13 is a diagram exemplifying a droop inclination and an offset regulation circuit. The regulators 45 and 46 described above include, for example, amplifiers 45a and 46a. The output control unit 48 adjusts the reference voltage VREF by adjusting the offset voltage input to the amplifier 45a, thereby adjusting the voltage offset of the drooping characteristic. The output control unit 48 adjusts the voltage of the current sense signals input to the amplifier 46a by adjusting the resistance value of the variable resistor 43, thereby adjusting the droop inclination.

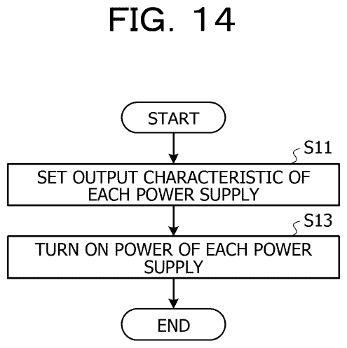

FIG. 14 is a flowchart illustrating exemplary operation of the device control unit. In operation S11, the device control unit 21 sets the output characteristic of each of the first power supply 11 and the second power supply 12. For example, the device control unit 21 sets a flag indicating whether to operate each power supply as a main power supply or as a standby power supply by the PMBus. In operation S13, the device control unit 21 turns on the power of each power supply.

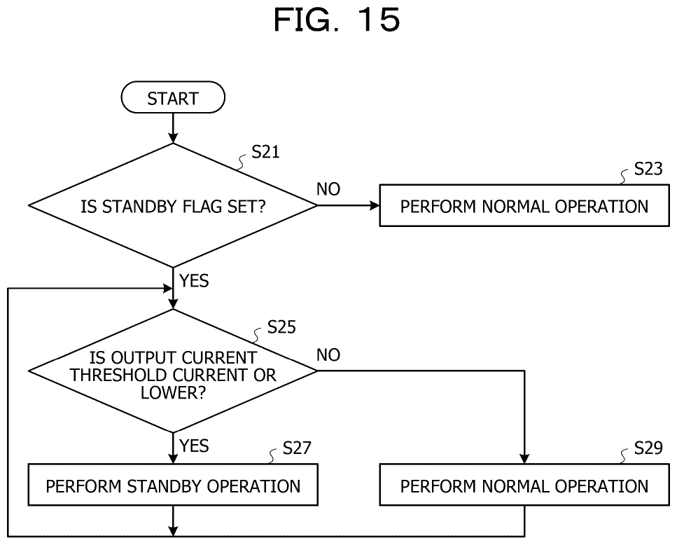

FIG. 15 is a flowchart illustrating exemplary operation of the power supply. The first power supply 11 and the second power supply 12 are activated by a power-on signal from the device control unit 21. In operation S21, the output control unit 48 of each of the first power supply 11 and the second power supply 12 refers to the flag stored in its own register 47, and determines whether or not a standby flag for operating as a standby operation is set. When the standby flag is not set, the output control unit 48 sets the output characteristic to the drooping characteristic at the time of normal operation to operate its own power supply as a main power supply (operation S23).

When the standby flag is set, the output control unit 48 operates its own power supply as a standby power supply. In this case, the output control unit 48 determines whether or not the output current of its own power supply is lower than the threshold current Ith (operation S25). When the output current is equal to or lower than the threshold current Ith, the output control unit 48 sets the output characteristic of its own power supply to the drooping characteristic at the time of standby operation (operation S27). When the output current is higher than the threshold current Ith, the output control unit 48 sets the output characteristic of its own power supply to the drooping characteristic at the time of normal operation (operation S29). The drooping characteristic may be switched by operations S25, S27, and S29.

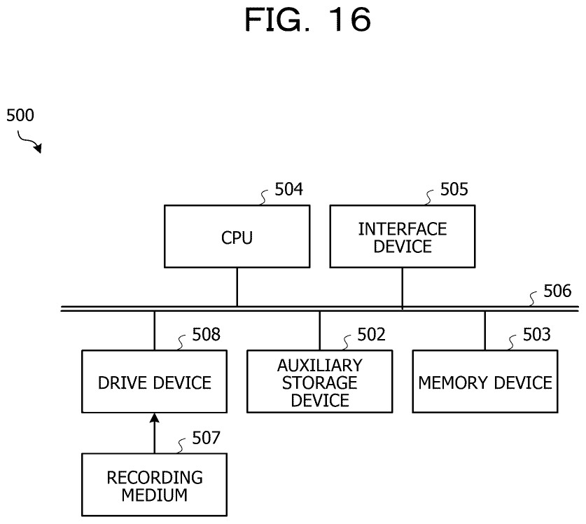

FIG. 16 is a hardware configuration diagram of a control unit. The device control unit 21 or a control unit (output control unit 48, PWM control unit 49, etc.) in each power supply described above may be implemented by a configuration like a control device 500. The control device 500 includes a drive device 508, an auxiliary storage device 502, a memory device 503, a central processing unit (CPU) 504, an interface device 505, and the like, which are mutually coupled to each other by a bus 506.

A program that implements processing in the control device 500 is provided by a recording medium 507. When the recording medium 507 recording the program is set in the drive device 508, the program is installed in the auxiliary storage device 502 from the recording medium 507 via the drive device 508. However, the program is not necessarily installed from the recording medium 507, and may be downloaded from another computer via a network. The auxiliary storage device 502 stores the installed program, and also stores files, data, and the like that are needed.

The memory device 503 reads the program from the auxiliary storage device 502 and stores it when an instruction to start the program is issued. The CPU 504 is a processor that executes a function related to the control device 500 according to the program stored in the memory device 503. The interface device 505 is used as an interface for coupling to the outside.

Note that, as an example of the recording medium 507, a portable recording medium such as a compact disc read only memory (CD-ROM), a digital versatile disc (DVD), a universal serial bus (USB) memory, or the like is exemplified. Furthermore, as an example of the auxiliary storage device 502, a hard disk drive (HDD), a flash memory, or the like is exemplified. Both the recording medium 507 and the auxiliary storage device 502 correspond to a computer-readable recording medium.

A program for causing the control device 500 to execute each processing described above may be stored in the auxiliary storage device 502. A database (DB) 501 may be stored in the auxiliary storage device 502 or the memory device 503.

While the embodiment has been described above, the embodiment described above is presented as an example, and the present disclosure is not limited by the embodiment described above. The embodiment described above may be implemented in various other forms, and various types of combinations, omissions, substitutions, changes, and the like may be made without departing from the gist of the disclosure. Those embodiments and modifications thereof are included in the scope and gist of the disclosure, and also are included in the disclosure described in the claims and the equivalent scope thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A power supply unit comprising:
a first power supply configured to:
set a first output voltage output to a first wiring to a first voltage when a first output current that flows through the first wiring is zero, and
decrease the first output voltage according to an increase in the first output current; and
a second power supply configured to:
set a second output voltage output to a second wiring to a second voltage lower than the first voltage when a second output current that flows through the second wiring coupled to the first wiring is zero, and
supply the second output current when the first output voltage decreases to the second voltage.

2. The power supply unit according to claim 1, wherein when the first output voltage decreases to the second voltage, the second power supply decreases the second output voltage according to an increase in the second output current.

3. The power supply unit according to claim 1, wherein when the first output voltage decreases to the second voltage, the second power supply decreases the second output voltage according to an increase in the second output current so that the second output voltage becomes equal to the first output voltage.

4. The power supply unit according to claim 1, wherein when the first output voltage decreases to the second voltage, the second power supply decreases the second output voltage according to an increase in the second output current so that the second output voltage becomes equal to the first output voltage and the second output current becomes equal to the first output current.

5. The power supply unit according to claim 1, wherein when the second output current is higher than a predetermined current, the second power supply decreases the second output voltage according to an increase in the second output current so that the second output voltage becomes equal to the first output voltage and the second output current becomes equal to the first output current.

6. The power supply unit according to claim 5, wherein when the second output current is lower than the predetermined current, the second power supply decreases the second output voltage according to the increase in the second output current so that the second output voltage becomes equal to the first output voltage.

7. The power supply unit according to claim 2, wherein when the first output voltage decreases to the second voltage, the second power supply decreases the second output voltage according to the increase in the second output current with an inclination same as an inclination at which the first output voltage decreases with respect to the increase in the first output current.

8. The power supply unit according to claim 2, wherein when the first output voltage decreases to the second voltage, the second power supply decreases the second output voltage according to the increase in the second output current with an inclination smaller than an inclination at which the first output voltage decreases with respect to the increase in the first output current.

9. The power supply unit according to claim 2, wherein the second power supply:
when the second output current is lower than a predetermined current, decreases the second output voltage according to the increase in the second output current with an inclination smaller than an inclination at which the first output voltage decreases with respect to the increase in the first output current, and
when the second output current is higher than the predetermined current, decreases the second output voltage according to the increase in the second output current with the inclination same as the inclination at which the first output voltage decreases with respect to the increase in the first output current.

10. A control method of a power supply unit including a first power supply that supplies a first output current to a first wiring and a second power supply that supplies a second output current to a second wiring coupled to the first wiring, the control method comprising:
setting a first output voltage output to the first wiring to the first voltage when the first output current is zero, and
decreasing the first output voltage according to an increase in the first output current; and
setting a second output voltage output to the second wiring to the second voltage lower than the first voltage when the second output current is zero, and
supplying the second output current when the first output voltage decreases to the second voltage.

11. The control method according to claim 10, wherein when the first output voltage decreases to the second voltage, the second power supply decreases the second output voltage according to an increase in the second output current.

12. The control method according to claim 10, wherein when the first output voltage decreases to the second voltage, the second power supply decreases the second output voltage according to an increase in the second output current so that the second output voltage becomes equal to the first output voltage.

13. The control method according to claim 10, wherein when the first output voltage decreases to the second voltage, the second power supply decreases the second output voltage according to an increase in the second output current so that the second output voltage becomes equal to the first output voltage and the second output current becomes equal to the first output current.

14. The control method according to claim 10, wherein when the second output current is higher than a predetermined current, the second power supply decreases the second output voltage according to an increase in the second output current so that the second output voltage becomes equal to the first output voltage and the second output current becomes equal to the first output current.

15. The control method according to claim 14, wherein when the second output current is lower than the predetermined current, the second power supply decreases the second output voltage according to the increase in the second output current so that the second output voltage becomes equal to the first output voltage.

16. The control method according to claim 11, wherein when the first output voltage decreases to the second voltage, the second power supply decreases the second output voltage according to the increase in the second output current with an inclination same as an inclination at which the first output voltage decreases with respect to the increase in the first output current.

17. The control method according to claim 11, wherein when the first output voltage decreases to the second voltage, the second power supply decreases the second output voltage according to the increase in the second output current with an inclination smaller than an inclination at which the first output voltage decreases with respect to the increase in the first output current.

18. The control method according to claim 11,
wherein when the second output current is lower than a predetermined current, decreases the second output voltage according to the increase in the second output current with an inclination smaller than an inclination at which the first output voltage decreases with respect to the increase in the first output current, and
wherein when the second output current is higher than the predetermined current, decreases the second output voltage according to the increase in the second output current with the inclination same as the inclination at which the first output voltage decreases with respect to the increase in the first output current.
